(19) United States
(12) Patent Application Publication
(10) Pub. No.: US 2014/0312588 A1
(43) Pub. Date: Oct. 23, 2014

(54) Swivel Wheel Mounting For A Scooter

(71) Applicant: Christopher John DAVIS, (US)

(72) Inventor: Christopher John Davis, Poole (GB)

(21) Appl. No.: 14/365,485

(22) PCT Filed: Dec. 13, 2012
(86) PCT No.: PCT/GB2012/000902

§ 371 Date: Jun. 13, 2014

(30) Foreign Application Priority Data
Dec. 13, 2011 (GB) 1121388.2

(51) Int. Cl. B60B 30/00; B62L 1/04

(52) U.S. Cl. CPC B60B 30/00; B62L 1/04
USPC 280/87.041

(57) ABSTRACT

Scooters typically have a fixed rear wheel and a rotating front wheel on a length forming a handle. Such scooters are not always able to be used to perform tricks and stunts because they have a fixed rear wheel that can inhibit this. In particular many children and adults wish to drift the rear wheel, or have it at oblique angle to the scooter's direction of movement. The present invention provides a scooter wheel mounting capable of forming in use a two wheeled scooter, wherein the rear wheel being provided on a rotatable seat.

### FIELD OF THE INVENTION

The present invention relates to a wheel mounting, more particularly a wheel mounting for scooters.

### BACKGROUND

Scooters and so-called mini and micro-scooters are popular forms of transport, especially favoured by children and young people.

After an initial period of success when mini-scooters and micro-scooters seemed to be ubiquitous but seemed to be a passing trend, increasing numbers of such scooters are being sold.

These scooters, mini-scooters and micro-scooters (hereinafter known collectively as scooters) are a common form of transport and activity for many children and adults. Typically they have a rear wheel and a steerable front wheel on a length defining a handle. Optionally the handle is foldable for ease of stowage, transport and for performing tricks or stunts.

The scooter can be easy to use for smaller children, but for older children potential for tricks and stunt riding is increasingly important. A fixed rear wheel can inhibit the performance and ease of stunts and tricks significantly.

In particular many children and adults wish to drift the rear wheel, or be able to adjust it to an oblique angle, for example to the direction of movement of the scooter.

### PRIOR ART

Accordingly a number of patent applications have been filed in an attempt to resolve the problem, including the following:

Published European Patent Application EP-A-2 329 866 (YAMABE) discloses a two-wheel skater with a handle. The skater comprises: a boarding part elastically twistable about a longitudinal axis; a rear wheel including a swivel caster that is attached to an underside of a rear part of the boarding part with a swivelling axis inclined in a traveling direction of the skater; and a handle for steering a front wheel.

Published European Patent Application EP-A-2 323 897 (WEINER) discloses a scooter comprising: a platform having a front end, a rear end, a bottom in the form of a longitudinal axis parallel to the ground and extending through the front end and the rear end of the platform. The front end comprises a front foot portion and the rear end comprises a rear foot portion.

A post is connected to the front end of the platform and extends generally upwards from the front end of the platform. A front wheel is connected to the post such that at least a portion of the front wheel extends below the bottom of the platform. An inclined caster is fitted to the rear end of the platform with at least a portion of the inclined caster extending below the bottom of the platform. The inclined caster is configured so that the scooter is capable of being propelled forward generally along the longitudinal axis by the application of a force to the rear foot portion.

U.S. Pat. No. 6,619,678 (VAN ARDENNE) discloses a two-axle vehicle such as a scooter, comprising a frame having a platform section, connected at the front to a steering column in which a front wheel is arranged on a steering rod. The frame, behind the platform section, has a back section or tailpiece on which a back wheel is arranged, the back wheel has an axle which is supported by a shaped part which can pivot freely with respect to the tailpiece about the pivot axis which is directed downwards at an acute angle with respect to a support surface (“the road”) for the two wheels.

The back section or tailpiece projects behind the back wheel area and said axis is directed forwards with respect to said support surface. The back wheel axle is situated in front of the said pivot axis.

Published International Patent Application WO-A-0202394 (UNIT et al) discloses a scooter, of the type comprising: a frame having substantially horizontal development, provided with footboard; a shaft operatively associated with a front end of the frame and free to rotate about its own longitudinal axis; a steering handle and a front wheel associated to the shaft at opposite sides. The scooter further includes: a support element located in correspondence with a rear end of the frame which is free to oscillate about a first axis of rotation substantially parallel to the footboard; at least two rear wheels are pivotally engaged to the support element at opposite sides, relative to the first axis of rotation and stably defining at least two bearing points on the same plane, regardless of the position of the front wheel and of the relative rotation of the frame and of the support element.

United Kingdom Patent GB 2 369 807 (PALMER) discloses a scooter comprising a foot platform, a rear wheel, a front wheel and a handle bar arrangement which steers the front wheel and which stands upright from the foot platform in order to provide support for a person riding the scooter. The rear wheel is such that it is pivotally mounted for rotation about a vertical axis whereby the rear wheel is able to be caused to run in a straight line, or at an angle, in order to enable the person riding the scooter to perform manoeuvres or stunts not attainable with scooter having a rear wheel incapable of rotating about a vertical axis.

U.S. Pat. No. 4,799,702 (WANG) discloses a scooter comprising: a frame having a longitudinal foot board and a steering assembly including an upright handle extending in front of said foot board; a front wheel operably connected to said steering assembly; a rear wheel; a flexible attachment means including a longitudinal horizontal rod secured to a bottom side of a rear portion of the foot board. The rod has a front end and a rear end. A joint member has a front portion pivotally connected to the rear end of the longitudinal horizontal rod for turning about a vertical axis.

The front portion of the joint member has a restraining bar which is transverse to, and attached securely to, the front portion of the joint member. The restraining bar has two opposite ends both terminating at a point away from the front portion of the joint member. The joint member further has a rear portion and a substantially U-shaped wheel carrying member for holding the rear wheel. A rear wheel carrying member has two arm members and an intermediate portion interconnects said arm members. The intermediate portion is connected to the rear portion of the joint member and a resilient means is connected to the front end of the longitudinal horizontal rod and is also connected to the ends of the restraining bar.

United Kingdom Patent Application GB-A-2 469 092 (SHOLES) discloses a variable wheel configuration vehicle, comprising: a front wheel, a rear wheel means, and a body carrying the rear wheel means. The rear wheel means comprises two wheel elements each carried on a respective member.

Each respective member is adapted to be inserted into and removed from a receiving part in the body and is engageable with locking means in the receiving part in two alternative positions.

A problem associated with many of the aforementioned scooters has been that they are not always able to be used to perform tricks and stunts because they have a fixed rear wheel that can inhibit this.

In contrast the present invention provides an easy to fit adjustment to a scooter, that may be used to cost effectively increase the lifespan of a scooter and its usage potential.

### SUMMARY OF THE INVENTION

According to a first aspect of the present invention there is provided a wheel mounting that has a wheel and is capable of being fitted to a scooter, wherein the wheel is mounted on a shaft and the wheel and shaft are supported by a rotatable means on the body of the wheel mounting.

According to the present invention there is provided wheel mounting in the form of an insert for a scooter body comprising: a wheel mounted on a rotatable seat and a lock means for connecting the mounting to the scooter body.

Advantageously the mounting is in the form of an insert for a scooter body comprising: a wheel mounted on a rotatable seat and a lock means for connecting the mounting to the scooter body.

In preferred embodiments the mounting is detachable and mountable to a plurality of scooters.

Ideally the mounting is appropriate for mounting to a rear portion of the scooter, in replacement of the scooter rear wheel. Typically the rear wheel is secured to a plate which is insertable in a slot in the scooter body. This configuration allows easy part replacement and construction of scooters.

In use, the mounting is inserted into and secured to the scooter body, ideally by way of bolts passing through lateral apertures, holes or lacunae formed in it. The holes allow insertion of bolts for securing either directly into threads formed in the body of the scooter or to a lock means, such as a lock nut on an opposite face of the body.

Ideally a lock nut is recessed so that it lies flush with a surface of the scooter body.

The mounting may be secured to the scooter body through lateral holes in the scooter body.

The mounting ideally provides a castor wheel, with a seat that enables full rotation of the wheel.

In this way a standard scooter may be simply and cost-effectively converted into a so-called drifting scooter, thereby allowing the scooter dual function and consequently saving money and space.

In some preferred embodiments, a lock may be included to prevent rotation of the wheel, in order for example to fix the wheel and prevent lateral rotation, when an ordinary scooter is desired.

The lock may be achieved by a resiliently deformable member, screw thread part or slidable tag.

Ideally said lock is easy to operate and may be acted upon to lock the wheel in a plurality of positions, at a plurality of angles with respect to the direction of travel of the scooter.

This lock may allow a user to preserve ordinary standard functionality of the scooter if required.

Preferably the mounting is adjustable in width and/or length. This adjustable nature serves to allow the mounting to be fitted into a range of different slots by allowing the mounting to be expanded to fit into a variety of sized openings. Likewise the mounting is dimensioned and shaped in such a way as to enable it to be inserted into or removed from the aperture defined in the scooter body, thereby enabling the overall length of the scooter to be adjustable.

In some embodiments the plate is secured to the body by the bolt that typically passes through the plate and acts to secure the plate to the scooter body.

In other embodiments separate analogous bolts or threaded pieces may be used to connect the wheel mounting to the scooter body.

In some embodiments the bolts are fitted with quick release closure, such as cam clips, or sprung nuts. Optionally sprung connectors may be used to connect the wheel mounting to the scooter body. Such sprung members include a resilient tongue that snaps into a recess or groove or slot. The sprung members may be formed on the wheel mounting and recesses or grooves or slots may be formed in the wheel mounting, or vice versa. An advantage of this embodiment is that the wheel mounting may be changed or replaced quickly and without tools.

In all the aforementioned embodiments, removal of the nuts and/or bolts is not a difficult task and may be easily facilitated, with minimal or no tools.

In other preferred embodiments there may be provided a brake means, wherein for example a resiliently deformable guard, arranged above a rear wheel, may be depressed in use onto the wheel, to impede its rotation.

The brake may be fitted to the mounting in such a manner that it is able to rotate with the wheel, for example being fitted to a common axle. Alternatively the brake is connected to the scooter body and extends across the top of the wheel.

It is preferable that the guard is shaped and arranged to have a similar radius of curvature to the wheel in order to maximise its effectiveness when pressed against the wheel in order to slow it.

In further embodiments the wheel mounting includes a simple form of shock absorber, such as a rubber washer or similar impact absorbing material, whereby vertical movement of the wheel is absorbed, rather than transferring impact to the rider.

Another advantage of sprung movement of the wheel is for example wherein the wheel is mounted on a sprung seat, as this permits a user to depress the mounting in order to sense the nature of the surface over which the scooter is being ridden, so as to obtain some feedback. This facilitates braking or alteration of the way in which the scooter is being ridden. The shock absorber therefore acts as suspension and may further provide new trick possibilities, such as standing on the wheel to apply a brake to it.

Preferably the mounting includes a deviated profile, wherein the wheel is supported by a surface which is at an angle to the scooter body. Preferably said angle is oblique such that surface of the wheel mounting is angled higher than the body in use.

This angle allows the rider to turn from left to right whilst also allowing the wheel to naturally return to a central position.

Preferred embodiments of the invention will now be described, by way of example only, and with reference to the Figures in which:

### BRIEF DESCRIPTION OF FIGURES

FIG. 1 shows an isometric view of a first preferred embodiment of a wheel mounting;

FIG. 2 shows a view from a side of the preferred embodiment shown in FIG. 1;

FIG. 3 show opposing end views of the embodiment;

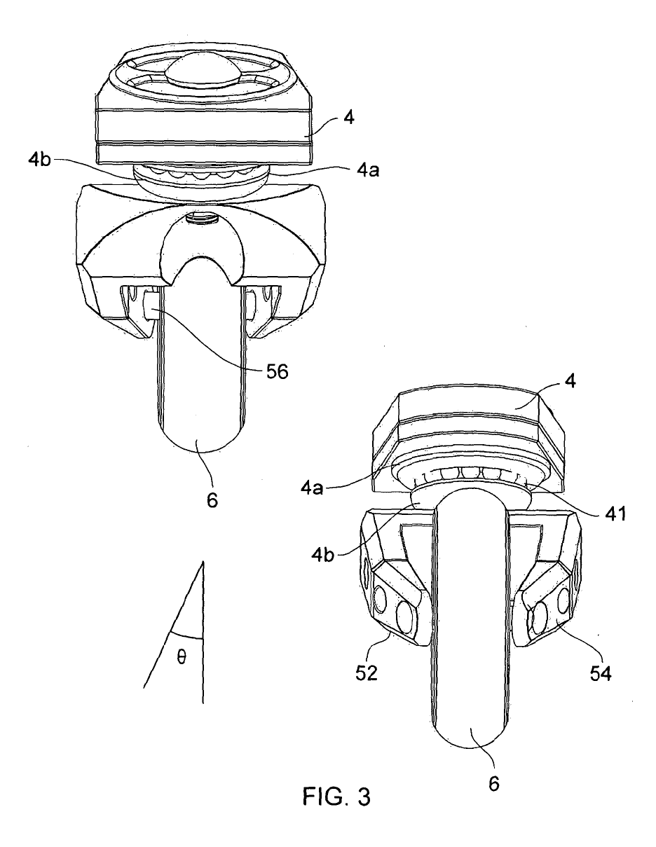

FIG. 4 show views from above and below of the embodiment; and

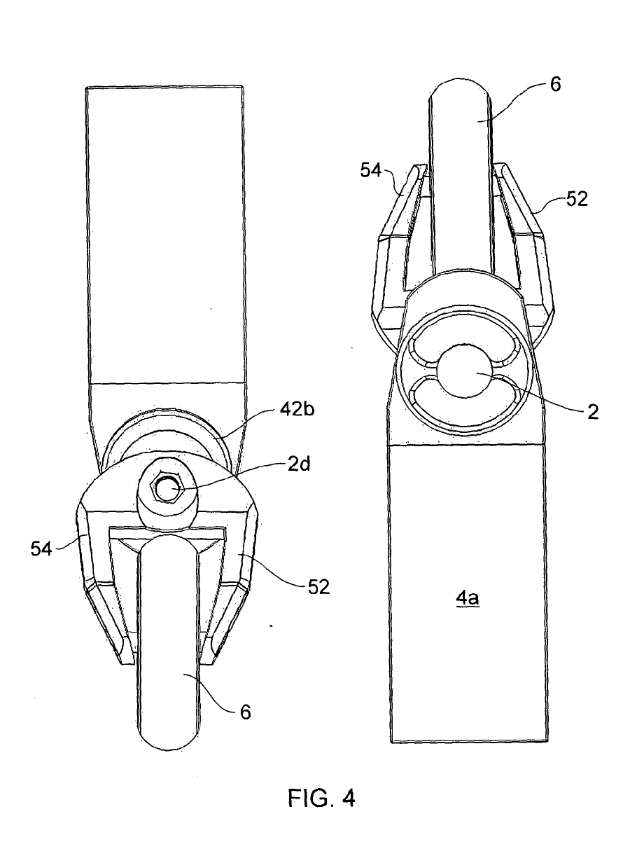

FIG. 5 shows an exploded side view of an alternative embodiment of a wheel mounting.

### DETAILED DESCRIPTION OF FIGURES

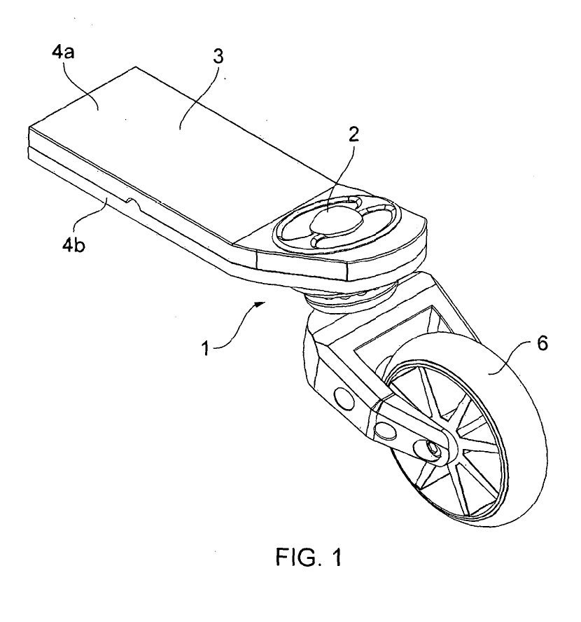

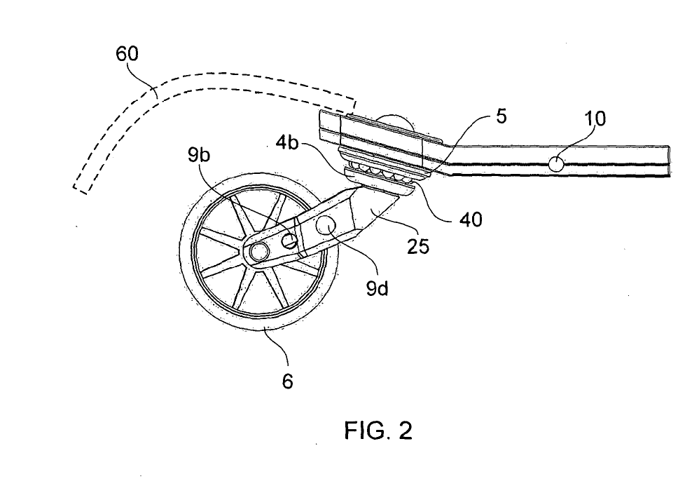

Referring to the Figures, and in particular to FIG. 1, there is shown an isometric view of a preferred embodiment of a wheel mounting 1 on which a wheel 6 is supported. A rear portion of a body 3 of a scooter (not depicted) is shown and comprises upper and lower body portions. The wheel mounting 4 is connected to a scooter body (shown in FIG. 2) by way of a quick release connector 2 which passes through the scooter body and the wheel mounting.

The wheel mounting 4 is a retrofit device and allows the rider (not shown) to ride the scooter in a particular manner—known as drifting. The scooter to which the wheel mounting 4 is applied, connected or attached, can be modified and returned to its original state simply by removing the wheel mounting 4.

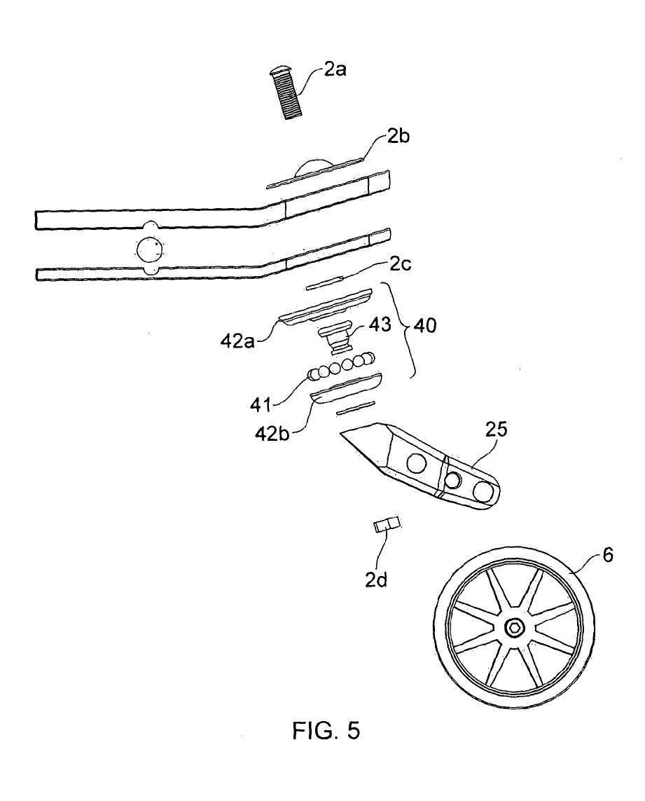

Wheel mounting 4 is optionally formed from a single body portion or is made up of two body portions—upper body portion 4a and lower body portion 4b. These body portions may be designed to attach to a scooter body or insert into a scooter body, as for example shown in greater detail in FIG. 5.

The embodiment depicted in FIG. 5 includes a castor 40 comprising an upper ball race 42a and a lower ball race 42b, enclosing bearing or rollers 41 in a sealed unit so as to prevent ingress of dirt, dust and moisture. The castor 40 is supported by and sits on a spindle 43. Spindle 43 passes through upper body portion 4a and lower body portion 4b and is locked in place by way of a threaded bolt 2a and lock ring 2b and washer arrangement 2c.

In the preferred embodiments, shown in the Figures, the wheel mounting can ideally be fitted onto any of the major brands of scooter quickly and easily, whenever or wherever needed. However, separate spacers or packing (not shown) of various thicknesses, may be included to allow the wheel mounting to retrofit onto any of the major scooter brands.

Spacers are ideally inserted into the scooter rear wheel plate slot, or a suitable aperture, in order to ensure the mounting may be fitted securely. The wheel mounting thereby allows for the conversion from park or road use to drifting without the need to buy a purpose built drifting scooter and so allows the user to drift and steer from the back of the scooter as well as at its front.

The wheel mounting is designed to enable a scooter to be customised with each part readily easy to change without the need for a tool box.

Referring to the remaining Figures, in which like parts bear the same reference numerals there is shown a wheel mounting for a scooter having the following: an aluminium top insert has an upper body portion 4a which is typically between 5 and 15 mm thick and is ideally substantially 10 mm thick. Ideally users can swap tops if they wish. A lower body portion 4b is ideally between 5 and 10 mm thick.

In use the user removes a pre-existing wheel mounting or bearing (not shown) from the rear of the scooter and replaces this with the wheel mounting according to the present invention. The wheel mounting 1 is fitted either adjacent to the surface so that holes line up or into an aperture defined in the scooter body.

In use therefore there is a method of modifying a scooter comprising the steps of: removing an existing rear wheel; fitting a wheel mounting, optionally selecting one or more spacers; thereby fitting the wheel mounting on the scooter.

Optionally bolts or lock means or catches need to be replaced and tightened so as to securely attach the wheel mounting to the scooter.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

For example the mounting may include lights and circuitry for emitting sounds. Lights might include light emitting diodes (LEDs) activated by inertia or pressure switches or remote switches, for example to mimic a flashing brake light of a racing car or motorbike. In other embodiments sounds such as engine roars, brake squeal or other simulated racing sounds may be generated by a suitable integrated circuit.

The invention has been described by way of examples only and it will be appreciated that variation may be made to the above-mentioned embodiments without departing from the scope of invention.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-30. (canceled)

31. A wheel mounting for a scooter in the form of an insert adapted to fit onto, or into, a rear portion of a scooter body, the wheel mounting comprising:
a wheel mounted on a rotatable seat; and
lock means for connecting the wheel mounting to the scooter body.

32. A wheel mounting according to claim 31, wherein:
the wheel mounting is connected to the scooter body through a shaft that normally receives a rear wheel axle.

33. A wheel mounting according to claim 31, further comprising:
means to adjust a width and/or a length of the wheel mounting, thereby allowing the wheel mounting to fit into a variety of sized openings.

34. A wheel mounting according to claim 31, further comprising:
means provided for varying an angle of an axle so as to alter an angle of deployment of the wheel with respect to a riding surface.

35. A wheel mounting according to claim 31, wherein:
the wheel mounting is inserted into, and secured to, the scooter body by way of a lock nut or bolt passing into a threaded recess formed in the scooter body and lies flush with a surface of the scooter body.

36. A wheel mounting according to claim 31, further comprising:
a castor enabling rotation of an axle supporting the wheel through 360°.

37. A wheel mounting according to claim 36, further comprising:
a lock provided to prevent rotation of the castor to fix the wheel in one orientation.

38. A wheel mounting according to claim 37, wherein:
the lock includes a resiliently deformable member, screw thread part, or slidable tag.

39. A wheel mounting according to claim 31, further comprising:
means to orient the wheel so that it is located at an angle to a plane with respect to a direction of travel of the scooter.

40. A wheel mounting according to claim 33, wherein the means to adjust the width and/or the length of the wheel mounting comprises:
a packing member, insert or wedge.

41. A wheel mounting according to claim 31 wherein:
the wheel mountings are fitted with quick release means.

42. A wheel mounting according to claim 41, wherein the quick release means comprises:
a cam clip, a sprung nut, or a sprung connector.

43. A wheel mounting according to claim 31, further comprising:
a brake to brake the wheel.

44. A wheel mounting according to claim 43, wherein the brake means comprises:
a resiliently deformable guard, arranged relative a rear wheel, adapted to be depressed onto the wheel, to impede rotation of the wheel.

45. A wheel mounting according to claim 43, wherein:
the brake is shaped and arranged to have a similar radius of curvature to the wheel to maximise braking effectiveness when pressed against the wheel to slow the wheel.

46. A wheel mounting according to claim 43, wherein:
the brake is fitted to a common axle of the wheel mounting to rotate with the wheel.

47. A wheel mounting according to claim 31, further comprising:
a shock absorber between the wheel and the scooter body so that vertical movement of the wheel is absorbed in preference to transferring impact to a rider of the scooter.

48. A wheel mounting according to claim 31, wherein:
the wheel mounting is formed from a cast metal.

49. A wheel mounting according to claim 31, wherein:
the wheel mount includes a deviated profile, wherein the wheel is supported by a surface which is at an angle to the scooter body.

50. A wheel mounting according to claim 31, wherein:
the wheel mount is suitable for use with one of a plurality of scooter bodies.
